(19) United States
(12) Patent Application Publication
(10) Pub. No.: US 2005/0146227 A1
(43) Pub. Date: Jul. 7, 2005

(54) Phone adapter for connecting auxiliary sound devices and an auxiliary hands-free device

(76) Inventors: Steven A. Jackson, Bayside, NY (US); Victor S. Manganaro, New Brunswick, NJ (US)

Correspondence Address: MCDERMOTT, WILL & EMERY, 600 13th Street, N.W., Washington, DC, 20005-3096, US

(21) Appl. No.: 10/748,687

(22) Filed: Dec. 31, 2003

(51) Int. Cl. H02B 1/24

(52) U.S. Cl. 307/113

(57) ABSTRACT

Phone and other communication device accessories include adapters and communication headsets for enhancing each of use. In the disclosed examples an adapter may selectively connect a phone or other communication devices to a first auxiliary device and a second auxiliary device. A dual retractable headset, as one type of auxiliary device, includes a retractable cord and includes disengagably connected microphone for various types of use. The adapter may include a transmitter for transmitting the signal received from the device to an auxiliary device or a transceiver for communicating with a corresponding wireless headset. Also, a mounting system includes a flexible arm and universal brace for attaching to most types of mounting surfaces.

### TECHNICAL FIELD

The concepts disclosed herein relate to a hands-free headset device and an adapter for selectively connecting a device (e.g. a phone or other device equipped with a duplex connector) to an external speaker system and a hands-free device.

### BACKGROUND

Personal communication devices have advanced and have become a necessity in the lives of many people. Coinciding with the growth of personal digital communication devices has been a growth in accessories available for these devices. This is especially true in the accessories market for cellular phones, which offers a wide variety of devices to provide comfort and convenience. Hands-free devices make up a significant portion of this cell phone accessories market, which includes hands-free headsets. Hands-free devices, as the name suggests, allows a user to talk on their phone without having to hold the phone in his/her hand. In addition to providing an element of comfort and convenience, hands-free devices have become an important key to safer cell phone operation, especially in vehicles. In fact, many states, as well as, individual counties in the U.S have pending legislation banning the talking on a cell phone while operating a vehicle unless used with a hands-free device. Internationally, some countries have already passed similar laws with more to follow. This growing trend will only serve to increase demand for hands-free devices. But, despite the growth and multitude of varying designs of hands-free devices claiming any combination of comfort, ease of use, convenience and better sound quality, most appear to have one or more operating flaws or deficiencies, as well as, a susceptibility to premature wear and/or breakage for even the casual user.

The basic idea of a hands-free device is to expand cell phone speaker functions and/or microphone functions apart from the phone itself so the user does not have to hold the phone to their face while talking. A common hands-free device is the hands-free headset, generally consisting of an earpiece and an attached microphone wired to a duplex male connector, which connects to a duplex jack provided on most cellular phones. Headsets vary by the size of the earpiece, how it attaches to the ear, and the type and location of the attached microphone. The earpiece may fit in the ear either on its own or with some kind of support attachment to the inside or outside of the ear. Several types of headsets on the market provide users with a near-custom in-ear fit with different size rubber or plastic fittings, which would then be placed over a mating earpiece and inserted into the user's ear. Problems with these various earpieces may include an earpiece fitting too snugly inside the ear so as to cause discomfort over a period of time. Also, the snug fit can cause a degradation on received sound quality due the effects on the inner ear. Moreover, certain movements can cause the earpiece to move or fall out. Various support attachments that hold the earpiece in place may be difficult to apply and not maintain a snug fit or uncomfortable to wear.

The microphone of a hands-free headset may be in-line with the cord and may be clipped to a shirt lapel or any other article of clothing conveniently located close to the mouth, or as part of a hard plastic tubing attached to the earpiece that extends toward the mouth at varying fixed lengths or by a telescoping mechanism. In many cases, those headsets with microphone assemblies that do not extend to the user's lips may not receive adequate sound volume and are more likely to pick up ambient noise. Also, sound can be distorted by the ambient conditions of the operating environment causing echoes or fading when not speaking directly into the microphone. This is especially the case with in-line microphones, as when the head is turned, the relative position of the microphone may change.

A recent variation of hands-free headset includes a retractable earpiece microphone combination. However, with the microphone positioned at the user's ear, the sound volume may not be adequate enough to be picked up and/or may be susceptible to ambient noise.

Other hands-free devices that are specifically designed for use in a vehicle incorporate an external amplified speaker that requires connection to a car's cigarette lighter to provide power. The microphone needs to be mounted in the car or clipped to the user's clothing. Besides providing power, the cigarette lighter/DC utility port is used to provide a point of mounting stability for the hands-free device, which includes the small speaker and cell-phone mount to hold the cell-phone in place. Mounting the typically low-output speaker in the area of the cigarette lighter, which is generally in a position low on the vehicle console, does not provide good transfer of sound to a user's ear especially with the engine and other environmental noises in the background. At higher speeds, the engine noise and road noise will interfere further with a user's hearing reception of the external speaker audio output. Those devices which do not provide a microphone rely on the internal microphone of the cell phone, which is usually too far away for adequate reception of a user's voice.

Another device uses an FM transmitter to send the sound received from a cellular/cordless phone's speaker to the FM tuner of a user's automobile or home stereo receiver and over corresponding speakers. A suction cup containing a microphone is clipped onto the phone's speaker in order to intercept sound to be transmitted that has already been amplified by the cell phone. However, sound quality is greatly compromised because in this method, the other party receives an FM modulated twice amplified audio signal introducing distortion by the additional amplification stages. Other problems include phone mounting positions which may be inconvenient requiring a user to disengage the phone from the mount when in use. Also, special mounting positions may be required to accommodate the spring-loaded suction cup, and proper microphone placement. All microphone issues previously mentioned may apply.

To date, despite a multitude of varying hands-free device designs offering any number of features, no single hands-free device on the market has been able to successfully address the operating issues and real-world demands of the casual or critical-use cell-phone user.

### SUMMARY

The concepts disclosed herein include an adapter for connecting a device outputting a signal to a first auxiliary device and a second auxiliary device. The adapter includes a first connector for receiving the signal output by the device and transmitting a different signal to the device. A first switch is connected to receive the signal from the first connector, and switches between a first position and a second position. A second connector receives the signal from the switch in the first position and outputs the signal to the first auxiliary device. A third connector receives the signal from the switch in the second position and outputs the signal to the second auxiliary device. The adapter may also include a second switch for switching between an open position and a closed position, wherein when in the closed position, the first connector receives the different signal output via the third connector.

A housing encloses at least one of the first switch, the first connector, the second connector, and the third connector. At least one connector is extendible from, and retractable to, the housing. When the at least one connector is in a retracted position, the at least one connector is flush with the housing.

A first wire of the connector connects to the first switch at one end and to the first connector at the other. A second wire connects to the second switch at one end and to the first connector at the other. The first wire and second wire are in a cable, which may be coiled. Also, the first connector, second connector, and third connector are connected by a ground line.

At least one of the second connector and the third connector may be a transmitter for transmitting the signal to the first auxiliary device and the second auxiliary device, respectively. In the alternative, a third switch may be switchable between a first position and a second position, for switching between the transmitter for transmitting the signal to a receiving device and the second connector.

An associated communication headset includes an earpiece adapted to interface with an ear of a user. A microphone boom having a microphone proximate to a first distal end of the boom, and a second distal end of the boom pivotally connected to said earpiece, permits user adjustment. A dual retractable cord operably associated with the earpiece and the microphone allows a user to retract the cord. A housing external to the earpiece and microphone boom is adapted to receive a portion of the dual retractable cord when retracted, and to receive another portion of the dual retractable cord when retracted, so as to contain the cord. When the portion of the dual retractable cord is substantially retracted, the earpiece engages the housing. Also, the microphone boom may be disengagably connected to the earpiece. The headset may include a retractable cord operably associated with the microphone boom, wherein the retractable cord is protracted from the earpiece when the microphone boom is disengaged.

In an another embodiment, a communication headset includes an earpiece adapted to contact an ear of a user, a microphone boom having a microphone proximate to a first distal end of the boom, and a second distal end of the boom pivotally and disengageably connected to said earpiece, and a retractable cord operably associated with the microphone boom, wherein the retractable cord is protracted when the microphone boom is disengaged. The retractable cord may be contained by the earpiece, and protracts from a point proximate to the second distal end and the earpiece when engaged. Also, the retractable cord may be contained by a housing external to the earpiece. Alternatively, the headset may include a transceiver configured to receive a signal from an external device and transmit a signal received from the microphone to the external device.

Additional objects, advantages, and novel features of the embodiments will be set forth in part in the description that follows, and in part will become apparent to those skilled in the art upon examination of the following and accompanying drawings or may be learned by practice of the invention.

### DESCRIPTION OF THE FIGURES

The drawing figures depict preferred embodiments by way of example, not by way of limitations. In the figures, like reference numerals refer to the same or similar elements.

FIG. 1 illustrates a high level block diagram of the adapter.

FIG. 2 illustrates a wiring diagram of the adapter.

FIG. 3 illustrates connections to the adapter.

FIG. 4 illustrates an alternative configuration of the adapter.

FIG. 5 illustrates use of the adapter with either a laptop personal computer or amplified speaker.

FIG. 6 illustrates use of the adapter with a home stereo receiver.

FIG. 7 illustrates an adapter including a transceiver and corresponding headset.

FIG. 8A illustrates a dual retractable headset and FIG. 8B illustrates a user wearing the headset.

FIGS. 9A and 9B illustrates adjustments of a headset and the headset assembly, respectively.

FIG. 10 illustrates a cord retracted in a dual retracted headset.

FIG. 11 illustrates a use of the adapter and headset.

FIG. 12 illustrates another embodiment of the adapter and headset.

FIG. 13 illustrates yet another embodiment of the dual retractable headset.

FIGS. 14A and 14B illustrates still another embodiment of the dual retractable headset and a user using the same, respectively.

FIG. 15 illustrates an ascetically shaped adapter

FIGS. 16A and B illustrate another of the adapter including a speaker in an open and closed position, respectively.

FIG. 17 illustrates the ascetically shaped adapter, and mounting device.

FIG. 18 illustrates yet another embodiment of the adapter rotatably connected to the mounting device.

FIG. 19 illustrates a brace for clasping to a mounting surface.

FIG. 20 illustrates another type of brace for clasping to a mounting surface.

FIG. 21 illustrates the ascetically shaped adapter, associated mount, communication device, and headset.

FIGS. 22A and B illustrates a device having an adapter and headset integrally connected.

FIGS. 23A and B illustrates another embodiment of the device having an adapter and headset of FIGS. 23A and B.

FIG. 24 illustrates a mounting system for a communication device adapter and communication device.

### DETAILED DESCRIPTION

The inventors have developed an accessory device, also referred to as an adapter, for a cellular phone, cordless phone, or any other device equipped with a duplex connector through which signals may be output from the device and externally input to the device. The accessory device selectively amplifies the output signal through either an existing amplification/speaker system or applying the output signal to an auxiliary device. A headset may connect to the accessory device for optimal performance and a truly hands-free environment.

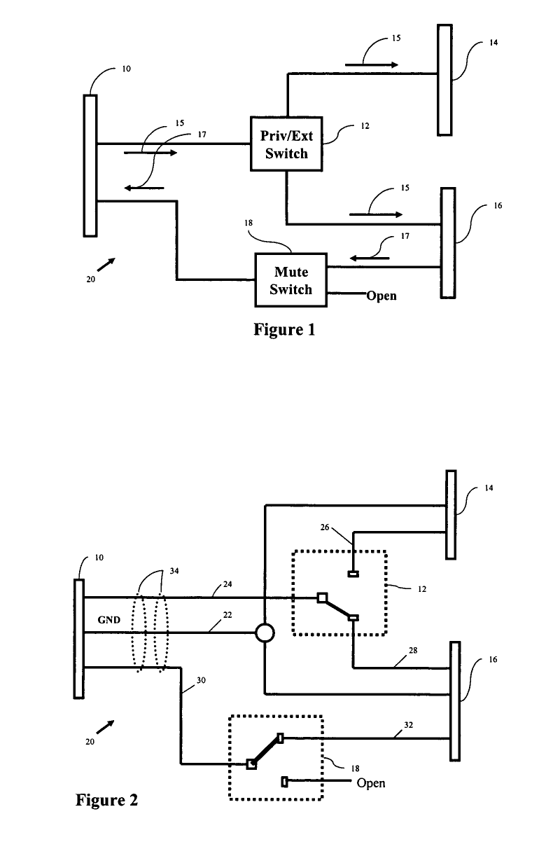

FIG. 1 illustrates a basic diagram of an adapter 20 having three connectors 10, 14, 16 and two switches 12, 18. Connector 10 may be a headset plug configured to connect to a cellular phone, cordless phone, or any other device having a duplex jack or other duplex-type connector, which may include proprietary jacks. Jacks are well within the level of one of ordinary skill in the art, are not explicitly discussed further herein, and shall not limit the invention.

Connector 10 is capable of transmitting at least two signals in opposite directions, as indicated by signal direction arrows 15 and 17. The first signal (i.e., signal 15) is output from a device to which connector 10 connects. The second signal (i.e., signal 17) is received by the device via connector 16. The signals input and output may be an audio or auditory signal. Other types of signals may be input and output via the connector 10 such as a data signal, a digital signal, an analog signal, or any other type of signal well within the level of one with ordinary skill in the art.

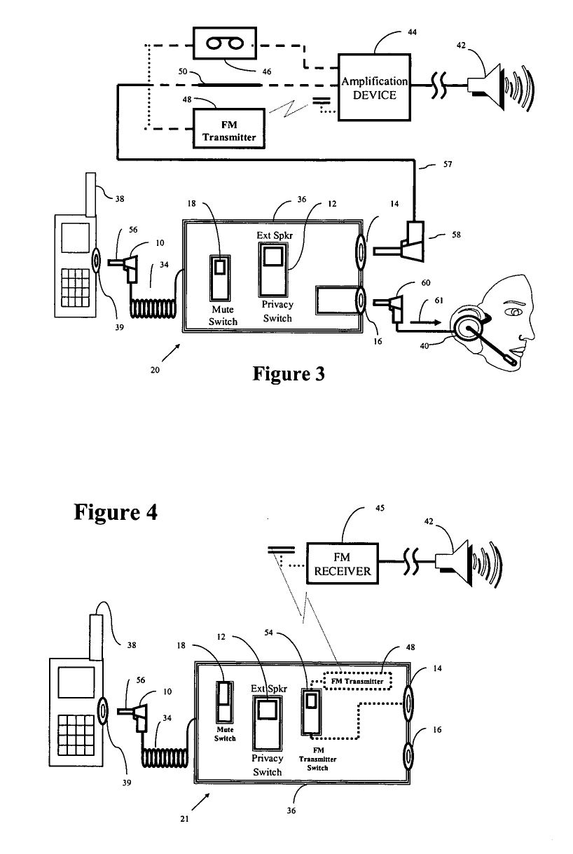

Privacy/External switch 12 receives first signal 15 output via connector 10 and transmits the signal to either connector 14 or connector 16 depending on the position of the privacy/external switch 12. Connector 14 may connect to an external sound amplification/speaker system, and connector 16 may connect to a hands-free headset (see e.g. FIG. 3). Devices other than an external sound amplification/speaker system and hands-free headset may be used.

Mute switch 18 is configured to receive the second signal 17 output from the hands-free headset or other device via connector 16. Mute switch 18 enables a user to open the connection between connector 16 and connector 10 so as to prevent the second signal 17 from appearing at connector 10. The mute switch 18 can be either mechanical (as illustrated in FIG. 2) or electronic, essentially providing similar results.

FIG. 2 illustrates a basic wiring diagram for adapter 20. A common ground wire 22 connects connector 10, connector 14, and connector 16. A first wire 24 connects connector 10 and switch 12. Wires 26 and 28 connect external/privacy switch 12 to connector 14 and connector 16, respectively. Moreover, a second wire 30 connects to the mute switch 18 and connector 10. On the other end of the mute switch, wire 32 connects to connector 16. The mute switch 18 is movable to a position to disconnect second wire 30 from wire 32, thus causing a microphone of to be in a muted state. Also shown in FIG. 2, first wire 24, ground wire 22 and second wire 30 or any lesser combination thereof may be formed in a cable 34. Advantageously, cable 34 eliminates excessive wires between connected devices.

FIG. 3 illustrates adapter 20 having a housing 36 for the privacy switch 12 and mute switch 18. Connectors 10, 14, 16 may be integrated within the housing 36, substantially flush with the housing 36, extendible from the housing 36, or any combination thereof (as shown). The mute switch 18 may be included in the adapter 20, or may be included on the handsfree-headset 40 closer to the microphone for better access to the user.

FIG. 3 also illustrates an external speaker 42 and amplification device 44 connecting to connector 14, and hands-free headset 40 connecting to connector 16. In this way, the external/privacy switch 12 may selectively output the received signal appearing on connector 39 from device 38 to the earpiece of the hands-free headset 40 or to the external speaker 42. When switched to the external position, a user is able to remove the hands-free headset's earpiece from his or her ear and listen to the received sound on the external speaker 42 while the microphone operates normally, providing a speakerphone-like function. One benefit is the improved comfort of not having the earpiece in the ear for all or part of the phone conversation. An equally important benefit is the improved sound quality resulting from the relatively significant amplification of a line level signal (the received sound appearing on connector 39 of device 38) driving relatively larger speakers as compared to the sound amplification driving the internal speaker of a typical cell phone or un-amplified line level signal that drives the earpiece of a headset. Another benefit, primarily during driving, is the reduced distraction of not having a user's ear covered or a user having to strain and/or concentrate to hear the other party speaking on the cell phone speaker or headset. In essence, use of adapter 20 overcomes the limitations of a cell phone's internal amplification/speaker system and/or headset combination.

Additionally, another speakerphone-like function which the adapter's external/privacy switch 12 provides is permiting other persons besides the user to hear the received sound (appearing on connector 39 of device 38) over an external speaker, thereby providing a “conference environment.” When privacy is desired in this conference environment, a user may switch to the privacy mode so that audio or auditory signals can only be heard through the earpiece of the user's hands-free headset 40 via connector 16 and not through the external speaker 42.

Also shown in FIG. 3, cable 34 may be coiled and connect to a cell phone 38 or other type of device in which amplification of its signal output is desired. The coiled cable 34 eliminates entanglement of the first wire 24, ground wire 22 and second wire 30 (see FIG. 2), and is more user-friendly as the coiled cable 34 is extendible only to a necessary position.

Connector 14 is integrated within and substantially flush with housing 36. Connector 16 may be retractable into housing 36 and extendible from the housing 36 permitting a user to extend the reach of the hands-free headset connector 16 to a comfortable and functional position. Any type of coil/re-coil device may be used for the retractable connector 16, as well as other retractable or coil/re-coil devices discussed herein. Also, connector 10 and connector 14 and associated wiring may be retractable into housing 36 depending a preferred design. Advantageously, any person within a reachable distance of the extended connector 16 and hands-free headset 40 may use the cellular phone 38 with relative comfort and ease. Moreover, a user may retract the hands-free headset connector 16 to a point so as to remove any excessive wires dangling or interfering with the user or other aspects or in the general environment of use.

In lieu of connector 16 being retractable, connector 60 and associated wiring of the hands-free headset 40 may be retractable into the headset (direction 61) in order to allow the hands-free headset 40 to be used, stored and carried in an organized fashion and to prevent tangling of the cord.

Once again referencing FIG. 3, when external/privacy switch 12 is in the external position, connector 14 outputs the line level audio signal appearing from the device 38 connector 39 to an amplification device 44 (via 3 methods) and heard over external speaker 42. Amplification devices defined herein may provide amplification of line level audio signals to be heard on an external speaker or multiple speakers. The amount of amplification will be determined by the power output rating of the amplifier of the amplification device. Examples of an amplification device, which may contain other functions besides amplification such as AM/FM tuning, cassette and CD playback, digital audio format playback, include a car stereo receiver, a home stereo receiver, a home or laptop computer (via their sound card), amplified speakers (like those used with home computers or portable CD players), or any other amplification device having external speakers 42 connected thereto. As connections to the various amplification devices differ, the inventors have devised various manners in which to connect the adapter to them.

FIG. 3 illustrates at least three ways of connecting the adapter 20 to an amplification device 44 for an audio signal to be heard over the external speakers 42. These are via a tape deck, an FM tuner and a direct cable. The method using a tape deck is primarily for use in a vehicle since many car stereo receivers include a tape playback unit. This would employ a CD-to-tape adapter 46, which passes the signal from connector 14 to the tape deck's playback head which is then amplified by the car stereo's internal amplifier and heard over the vehicle's speakers.

The next method makes use of the existing FM tuner/receiver that is part of a typical vehicle or home stereo receiver or even through a computer (with an FM tuner card installed). By connecting an FM transmitter 48 to adapter 20, the output signal at connector 14 is frequency modulated and transmitted over a predetermined FM frequency, which would then be received by the FM tuner/receiver, amplified and heard over speaker 42. The FM transmitter 48 may connect directly to connector 14 preferably via a male plug 58 with or without cable 57 The advantage of this method is that no physical connection is required between the adapter and the FM tuner/receiver 45 since the audio signal is transferred via radio waves. In an alternative, as shown by FIG. 4 illustrating adapter 21, the FM transmitter 48 could be incorporated within housing 36, thus obviating a need for connection to connector 14. In another alternative, also shown in FIG. 4, the FM transmitter 48 could be incorporated within housing 36 and be switchable between the FM transmitter 48 and connector 14 via a switch 54 thereby allowing many types of connections using the same device. The FM transmitter 48 may need to be powered by an external source. The FM transmitter 48 may be battery powered, or be powered by another power source which are known to those or ordinary skill in the art.

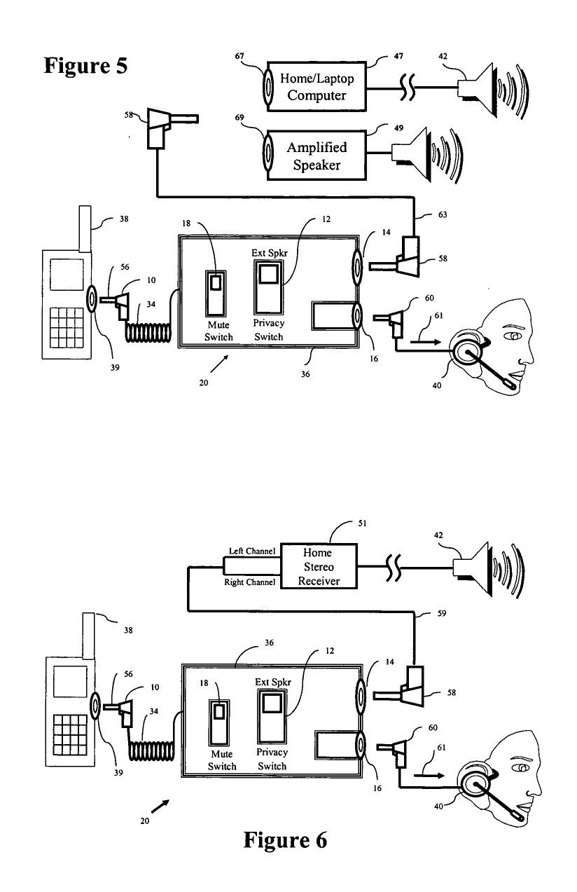

Shown in FIG. 3, a third alternative for connecting connector 14 to an external speaker system 42 is by way of a direct cable 50 consisting of 3.5 mm tri-conductor (stereo) male plugs 56 on each end. This connection would be used for connection to most laptops and home computers 47, as shown in FIG. 5-A, via its audio line input jack 67 by way of direct cable 63. Additionally, as shown in FIG. 5-B, is connection of the adapter to amplified speakers via its 3.5 mm stereo input jack 69 by way of direct cable 63. This may allow a user the flexibility to use their cell phone as a speakerphone at home or away, such as in a hotel room when on a business trip, by simply connecting the adapter to a portable battery-operated amplified speaker (although other power sources which are known to those or ordinary skill in the art may be used). The direct connection method may also be employed in some vehicles with stereo receivers equipped with an auxiliary 3.5 mm jack (not shown but similar to jack 67) typically used for connection to MP3 players and other auxiliary devices. Other types of direct cable connection may be employed. Another direct cable connection, as shown in FIG. 6, may be to a user's home stereo receiver via a stereo 3.5 mm male-to-dual RCA connector cable 59. In effect, a cell phone may operate as a speakerphone using a user's home stereo system.

FIGS. 3-6 illustrate jacks 56, 58, 60 for connecting to a cell phone 38, connector 14 and connector 16, respectively. Typically, jacks 39 on a cell phone 38 are 2.5 millimeters, requiring a 2.5 millimeter plug 56. Preferably, plugs 56 and 60 are 2.5 millimeters for connecting to standard cell phone jacks. PC and laptop computers have audio input jacks that typically use a 3.5 millimeter jack similar to adapter jack 14, 58 and accept 3.5 mm plugs 58, 67 and 69. However, the size of plugs is not limiting to this invention. As is well known to one of ordinary skill in the art, there are varying sizes of plugs and jacks that may be used.

Another novelty of adapter 20 is the availability of connector 16, which may provide a user with the flexibility to use any hands-free headset of their choice. Since headsets come in so many variations, headset selection can be a very personal decision and actually key to optimum sound quality, convenience, and ease of use to the user.

Several tests were conducted with adapter 20 in which an auditory signal from a cell phone or cordless phone was amplified through an external speaker system using the external/privacy switch 12 in the external speaker mode. The environments included a car using its stereo receiver and associated 4 speakers (two in the rear and one on each door), a one bedroom apartment using a Sony 100 watt stereo receiver and two Bose bookshelf speakers, a personal computer connected via its sound card to the previously mentioned home stereo and laptop computer via its internal speakers. Microphones with and without noise cancellation technology were also tested. In each environment, especially a small enclosed one like that of a car, microphones without noise cancellation were more susceptible to picking up ambient sounds as compared to microphones with noise cancellation. More particularly, the microphone received sound heard over the external speakers, especially when the placement of the microphone was too far from the user's mouth or too close to the external speakers. This also caused distortion and feedback, and in the worst case, an echo. Echo is created when in the external speaker mode, the user's microphone picks up the received sound or voice heard over the speakers and transmits it back to the other person on the call, thereby causing them to hear what they just said a second time with a varying delay. There were fewer to minimal occurrences of impeding distortion, feedback and echo using a noise-cancellation microphone. Optimum microphone placement and proper speaker volume (relative to the size of the operating environment) are also important factors in reducing those problems. As a result, it is preferable to use a noise cancellation microphone in order to reduce the possibility of feedback in either the external speaker system or an echo heard by the recipient. Other microphones known to those or ordinary skill in the art that prevent an echo or feedback from occurring may be used.

In order to optimize the functioning of the adapter 20, it is important to provide a hands-free headset that takes advantage of the benefits of adapter 20, as well as providing its own. Discussed herein will be headset features and headset designs which will enhance the adapter's performance and best work cooperatively with the adapter. Additionally, other adapter variations improving upon its hands-free capability and in conjunction with the various headset designs will be discussed.

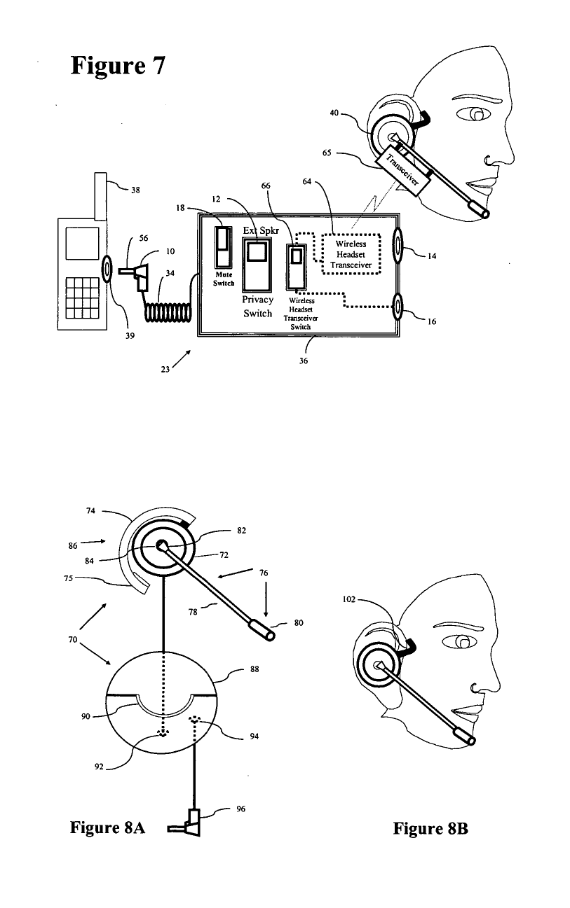

FIG. 7 illustrates a wireless headset, which may use the emerging standard BLUETOOTH™ technology. A wireless headset includes a transmitter/receiver (transceiver) which uses radio waves within a specific frequency band over a short range to transmit and receive the auditory signals (sounds) to and from a corresponding transceiver within or connected to a cell phone. This eliminates the need to have a wire connection between headset and phone. The most popular frequency band for short range wireless transmission used by wireless headsets is currently 2.4 Gigahertz. This includes BLUETOOTH™ which operates at 2.45 GHz using its own communication handshaking scheme.

Headset 40 may include a transceiver 65 that communicates with a corresponding transceiver 64 that is either externally connected to connector 16 (not shown) of adapter 20 or incorporated within adapter 20 housing 36. In yet another alternative, the transceiver 64 may be switchable between the headset wireless transceiver 64 and connector 16 via a wireless headset transceiver switch 66.

In another embodiment, the hands-free headset assembly 70 of FIG. 8a includes hands-free headset 86, dual-retractable wire assembly 88 and connector 96. The hands-free headset 86 includes earpiece assembly 72, earpiece support 74, microphone assembly 76, and earphone-microphone assembly pivot 84. The headset earpiece assembly 72 includes a speaker of an appropriate size to fit over the opening of the ear. This avoids discomfort from long-term use caused by the in-ear type speakers, although, in-ear speakers may be used. The earpiece assembly 72 may be held in place by a behind-the-ear support 74 which attaches to the earpiece assembly 72 at a point 102, as shown in FIG. 8b. Ear support 74 may have a slight bend at its end 75 to accommodate attachment to either the right or left ear and vary in length from half to full length of the ear. The earpiece assembly 72 is held in place by positioning it in back of the ear until the earpiece support 74 makes substantially full contact with the back of the ear, while point 102 rests where the ear connects to the side of a user's head. The earpiece assembly 72 may be permanently or detachably affixed to the support 74 at point 102. It may have a seamless fit or some form of mechanical fitting which holds it in place or allows the earpiece 72 to pivot or hinge at point 102 a small distance away from the ear for relief. Additionally, the earpiece assembly 72 may include a fitting at point 102 that allows an interchangeable earpiece support 74 for use on the right or left ear. Headset 86 and connector 96 are retractable into housing 88 at points 92 and 94, respectively.

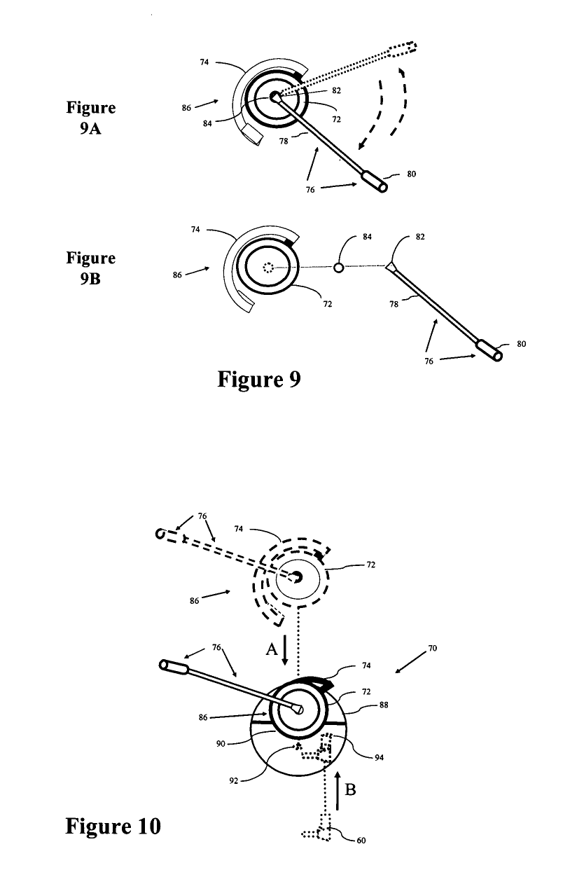

Microphone assembly 76 includes a noise cancellation microphone 80, a microphone boom made of flexible tubing 78 of varying length which extends the microphone 80 to near proximity of the user's mouth, and a pivot ball 84 and socket 82. Rigid tubing 78 may also be used. The flexible tubing 78 may be bent while holding its shape in order to place the microphone 80 into a user-preferred specific position. The pivot ball 84 and socket 82 allows the microphone assembly 76 to rotate, as shown in FIG. 9a, for optimum microphone placement. Also, it allows a user to move it away from his/her mouth when not in use, when the user is just listening and not speaking, or when the user is speaking for another purpose while listening to the other party's conversation.

The microphone assembly 76 may also be removed from the earpiece assembly 72 by disengaging the microphone assembly pivot socket 82 from the earpiece-microphone assembly pivot ball 84, as shown in FIG. 9b. This allows the microphone 80 to be used without the earpiece assembly 72 or interchanged with other types of microphone assemblies.

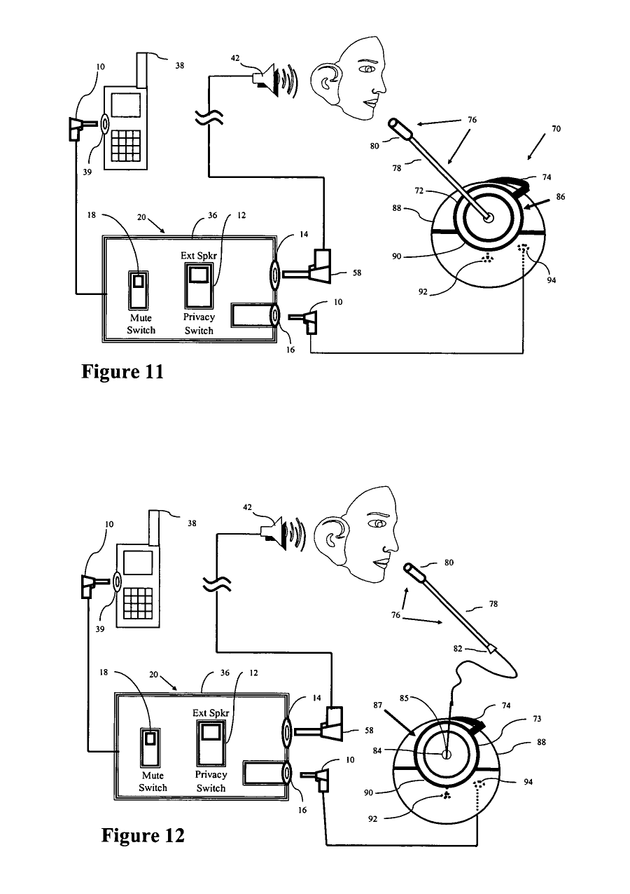

FIG. 10 illustrates a dual-retractable headset housing 88, a first retractable assembly (not shown) for the hands-free headset 86 to retract into a mated holster 90 on a side of the housing 88, and a second retractable assembly (not shown) to retract connector 60. Although retractable assemblies (coil/re-coil mechanisms) are not shown, they are well within the level of one of ordinary skill in the art. Advantageously, a user may retract the headset 86 into the housing holster 90 as shown by arrow-A of FIG. 10, and may use the microphone assembly 76 without having to wear the headset while adapter 20 is in the external speaker mode, as shown in FIG. 11. Also, a user may retract the headset plug 60 to housing 88. A mounting clip may be attached to the rear of the housing 88 in order to mount to a point on the user's clothing within a close proximity to the user's mouth. Also as shown by FIG. 10, both the hands-free headset 86 and plug 60 retract to the housing 88 (arrows A and B, respectively). In this manner, the hands-free headset unit may be more streamlined, and compact and easier to store and transport.

FIG. 12 illustrates another embodiment of a hands-free headset 87 having a retraction assembly (not shown) inside the earpiece assembly 73. Thus, the microphone assembly 76 can be extended from the hands-free headset 87. This allows the microphone assembly 76 to be mounted and used independently from both the hands-free headset 87 and the headset housing 88.

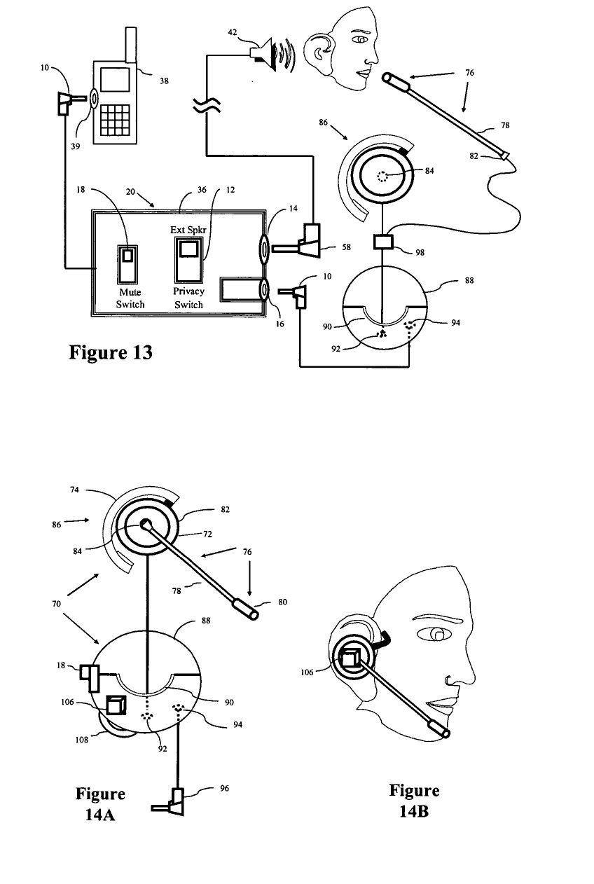

As shown in FIG. 13, in lieu of an internal retraction unit built into the earpiece assembly 72 to extend the microphone assembly 76, an external retraction assembly 98 can be used to independently to extend the microphone to the user's mouth, and adjust the length of the wire 99 connecting headset 86 and housing 88.

An important function to add to the headset assembly 70 that will increase the overall handsfree capability provided by the adapter/headset, may include an on/off button 106, as shown in FIGS. 14a and 14b. When an on/off button 106 is momentarily depressed, it allows a user to answer or end a call without having to handle or manipulate their cell phone. It also allows a user to initiate voice-activated dialing for those cell-phones so equipped, eliminating the need to handle the phone for dialing. The on/off button 106 is a momentary switch electrically in series with the microphone and may be mounted anywhere on the hands-free headset assembly 70 that will be convenient for the user to depress. FIGS. 14a and 14b shows the on/off button 106 alternately mounted on the headset assembly housing 88 and microphone assembly 76, respectively. FIG. 14a also shows a mute switch 18 that may be located on the headset assembly housing 88 or mounted anywhere on the hands-free headset assembly 70 that will be convenient for the user to depress. A volume control 108, which may also provide amplification of the audio signal, may also be included on the headset or in-line with the cord or on the headset housing as shown in FIG. 14a or mounted anywhere on the hands-free headset assembly 70 that will be convenient for the user to access.

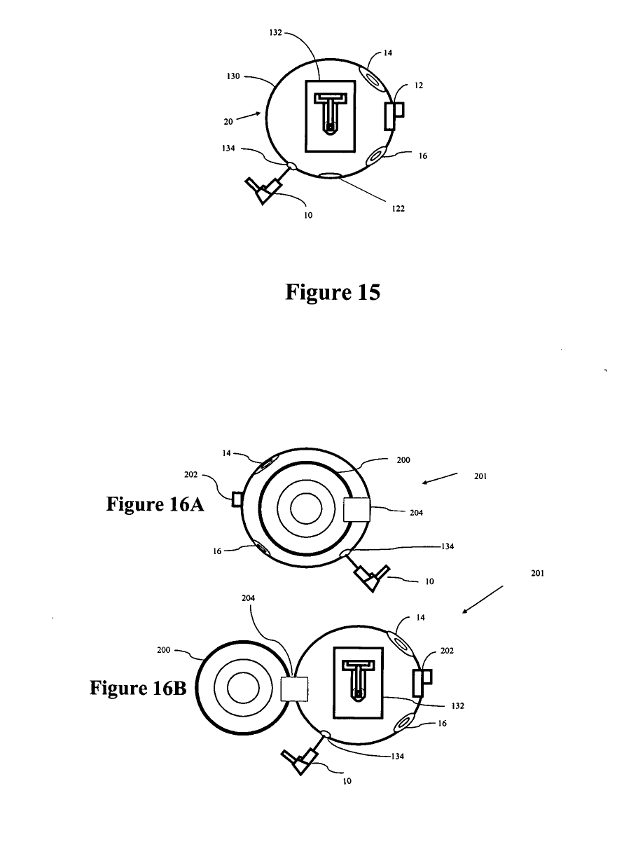

FIG. 15 illustrates adapter 20 with ergonomically shaped housing 130. Other adapter variations discussed herein may be similarly shaped. A cell phone mount 132 may be added to a side of adapter 20 to allow a user's cell phone to be conveniently and optimally mounted to enhance the hands-free functionality. The mount 132 may accommodate a commonly used cell phone mounting scheme of button and socket in which the button is affixed to the rear of a cell phone and connects and interlocks to a mating female socket (typically part of a belt clip or car dash mount). The mount 132 may accommodate other mounting mechanisms.

FIGS. 16A and B illustrate yet another embodiment of the adapter 201. An external speaker 200 is pivotally attached by a hinge 204, for example, to adapter 201. FIG. 16A shows the speaker 200 in a closed position and engaging a back side of the 201, and FIG. 16B illustrates a front view of the adapter 201 with external speaker 200 in an open position. When in use, speaker 200 may be positioned by the pivot connection for optimal user reception. Speaker 200 may be driven by an amplifier (not shown) wired and mounted internally within adapter 201 and may be powered by batteries for portability. The speaker 200 may also be powered by another power source which are known to those or ordinary skill in the art. Switch 202 may be a 3-position switch which switches the received audio signal appearing on connector 10 to a headset via connector 16 or to an attached external speaker 200 or to an amplification device/external speaker via connector 14.

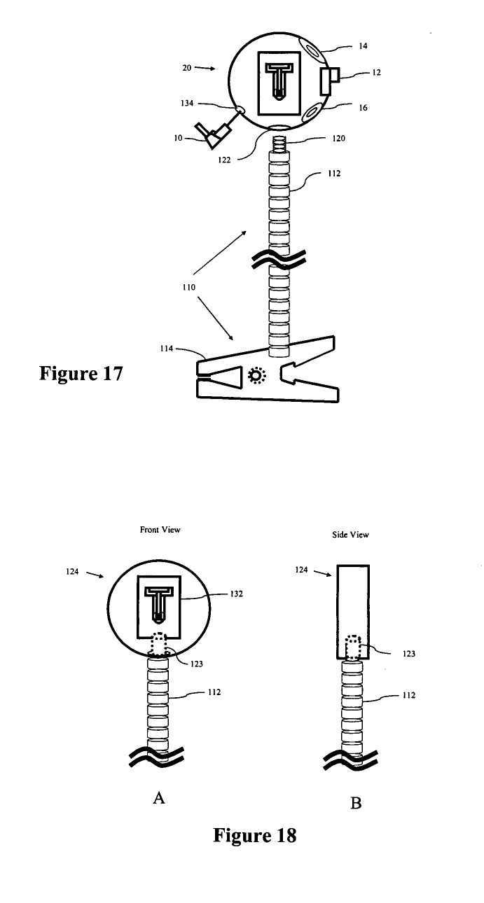

FIG. 17 illustrates a mounting system 110 for mounting adapter 20 and a cell phone 38 (via cell phone mount 132) to a convenient and stable point in the operating environment. The mounting system 110 is comprised of a flexible arm 112 (such as gooseneck type) of varying length, a stabilizing mount 114 on one end, such as a clip. A fastener 120 on the other end interlocks with adapter 20. Any male 120/female 122 interlocking mechanism or other interlocking mechanism may be used. Flexible arm 112 may be of a material which when bent, firmly maintains its shape so as to place the adapter 20 at the most optimum and stable operating position. It also may have the ability to telescope so as to vary its length for optimum mounting height or to shorten its length for more convenient storage or transporting. There may include a ratchet function (shown in FIGS. 18a and 18b) that would allow the adapter 20 to be rotated and locked in several positions to provide optimum placement for a user depending where clip 114 is attached.

FIGS. 18A and B illustrates ratchet 123 integrated with an adapter 124, which includes any of the adapters discussed herein. Adapter 124 is incrementally rotatable in 360 degrees, and lockable in a selected position chosen by a user. FIG. 18A illustrates adapter 124 at 0 degrees, and FIG. 18B illustrates adapter at 90 degrees.

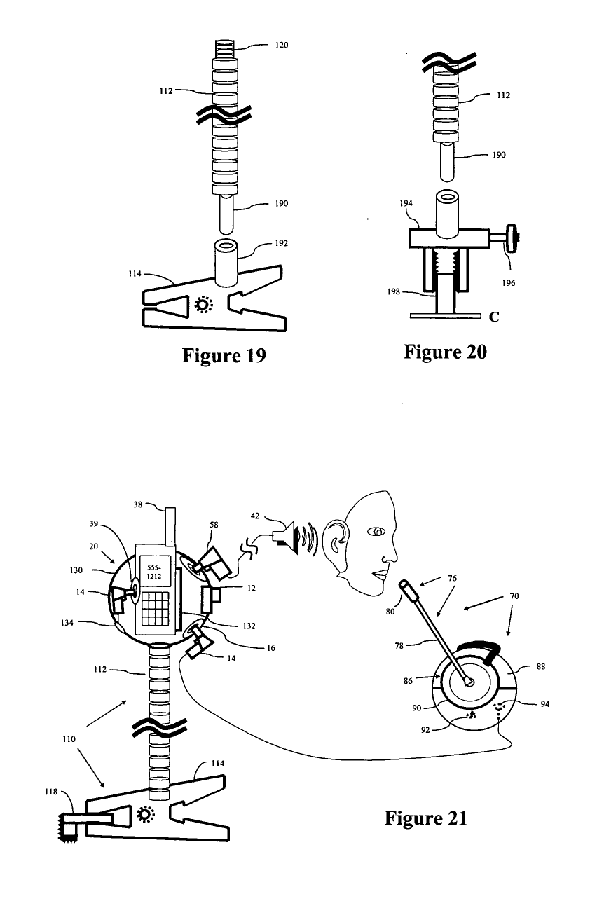

As seen in FIG. 19, a brace such as clip 114 should have a large enough footprint (when open) to accommodate being clipped to many different mounting surfaces in a car or at home. The clip may be coated with a non-abrasive and moderately frictional material 116 for good gripping ability without harming the mounted surface. Devices with other mounting capabilities may be used to keep mounting arm 112 stable, and are known to those of skill in the art.

FIG. 20 illustrates a brace such as vise 194 having gripping surfaces opposing one another and axially connected via a screw 196. The opposed gripping surfaces engage a mounting surface 198 by turning screw 196.

In FIGS. 19 and 20, arm 112 includes a rigid male connector 190 that mates and may lock with a corresponding female connector 192 on the clip 114 or vise mount 194 to hold the arm 112 in place. Any male 190/female 192 interlocking or other interlocking mechanism may be used.

FIG. 21 shows an example of an optimum hands-free scenario, implementing the interconnection of the cell phone 38, adapter 20 with housing 130 and cell phone mount 132, hands-free headset assembly 70 and mounting system 110 (in a configuration similar to that in FIG. 11) showing the adapter 20 in external speaker mode and the microphone assembly 76 being used without the headset 86 attached to the user's ear.

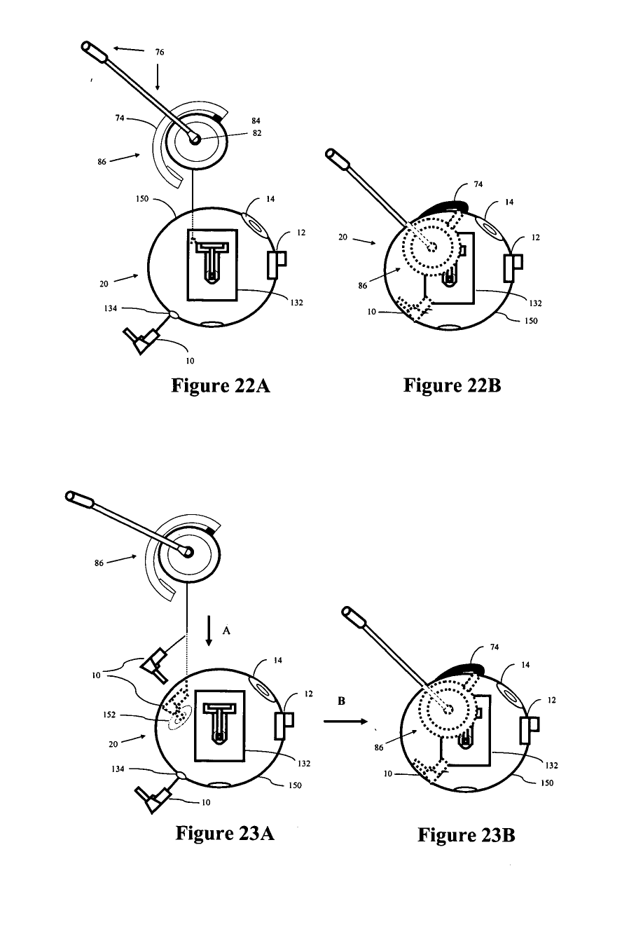

An alternate version of connector accessory may have the adapter 20, housing 130 and the hands-free headset 86 combined together so as to provide one streamlined device, adapter housing 150 as shown in FIGS. 22A and B. The headset 86 may retract into the rear of the adapter 150 via retraction assembly (not shown) as shown in FIG. 18b. Therefore, the two devices may be merged into one. Since the headset 86 is directly connected and retractable to adapter 150, there may be no need for connector 16 and therefore one less connection to make when setting up the adapter for operation. Also, headset assembly housing 88 may be eliminated in this manner.

As shown in FIG. 23, a release (not shown) may be provided in the rear of housing 150 that allows the headset 86 to be disengaged from the assembly 150. The headset could then be used independently with a cell phone or other device. A connector 152 would be located in the rear at the point of release that accepts the connecting male connector of the headset 86.

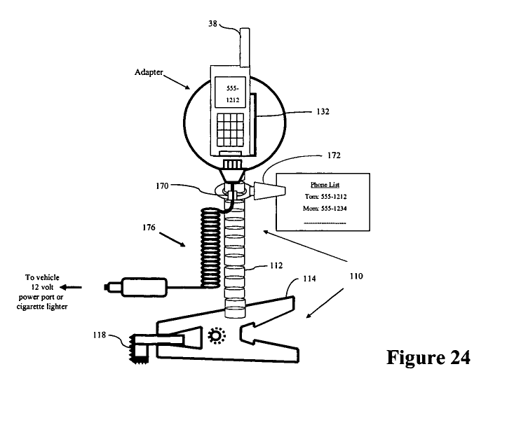

FIG. 24 illustrates the interconnection of the cell phone 38, adapter discussed herein, hands-free headset assembly 70, mounting system 110, and a power cable 176 for connecting the cell phone 38 to a power outlet, such as a 12 volt power port or cigarette lighter in a vehicle. A clip 170 may be included on the mounting arm 112 to hold the power cable 176 in place during operation and for easy access while connecting and disconnecting the power cable 176 from the cell phone 38. Additionally, another clip 172 which may function similar to power cable clip 170 may be included on the mounting arm 112 to hold a phone list or other source of information that a user can easily view or access.

All the foregoing has described what are considered to be the best mode and/or other preferred embodiments. It is understood that various modifications may be made therein and that the invention or inventions disclosed herein may be implemented in various forms and embodiments, and that they may be applied in numerous applications, only some of which have been described herein.

1. An adapter for connecting a device outputting a signal to a first auxiliary device and a second auxiliary device, comprising:
a first connector for transmitting the signal output by the device and transmitting a different signal to the device;
a first switch for receiving the signal from the first connector, and for switching between a first position and a second position;
a second connector for receiving the signal from the switch in the first position and for outputting the signal to the first auxiliary device; and
a third connector for receiving the signal from the switch in the second position and for outputting the signal to the second auxiliary device and for receiving the different signal from the second auxiliary device.

2. The apparatus according to claim 1, further comprising a second switch for switching between an open position and a closed position, wherein when in the closed position, the first connector receives the different signal output via the third connector.

3. The adapter according to claim 1, further comprising a housing for at least one of the first switch, the first connector, the second connector, and the third connector.

4. The adapter according to claim 3, wherein at least one of the first, second, and third connectors is protractable from, and retractable to, the housing.

5. The adapter according to claim 4, wherein when the at least one connector is in a retracted position, the at least one connector is substantially flush with the housing.

6. The adapter according to claim 2, further comprises:
a first wire for connecting to the first switch at one end and to the first connector at the other end; and
a second wire for connecting to the second switch at one end and to the first connector at the other end,
wherein the first wire and the second wire are formed in a cable.

7. The adapter according to claim 6, wherein the cable is coiled.

8. The adapter according to claim 6, wherein the first connector, second connector, and third connector are connected by a ground line.

9. The adapter according to claim 7, further comprising a housing for the first switch and the second switch.

10. The adapter according to claim 9, wherein the first wire, second wire, and ground wire are in the cable between the first connector and the housing.

11. The adapter according to claim 1, wherein the second connector is a transmitter for transmitting the signal to the first auxiliary device.

12. The adapter according to claim 1, further comprising:
a second switch switchable between a first position and a second position; and
a transmitter for transmitting the signal to the first auxiliary device when the switch is in the first position,
wherein the second connector, for connecting to the first auxiliary device, receives the signal when the second switch is in the second position.

13. The adapter according to claim 1, wherein the third connector is a transceiver for transmitting the signal to and receiving the different signal from the second auxiliary device.

14. The adapter according to claim 1, further comprising:
a second switch switchable between a first position and a second position; and
a transceiver for transmitting the signal to and receiving the different signal from the second auxiliary device when the switch is in the first position,
wherein when the second switch is in the second position, the second connector receives the signal.

15. The adapter according to claim 1, wherein at least one of the first connector and the third connector is a duplex connector for simultaneously transmitting signals in opposite directions.

16. A communication headset, comprising:
an earpiece adapted to interface with an ear of a user;
a microphone boom having a microphone proximate to a first distal end of the boom, and a second distal end of the boom pivotally connected to said earpiece;
a dual retractable cord operably associated with the earpiece and the microphone; and
a housing external to the earpiece and microphone boom adapted to receive a portion of the dual retractable cord when retracted, and to receive another portion of the dual retractable cord when retracted.

17. The communication headset according to claim 16, wherein when the portion of the dual retractable cord is substantially retracted, the earpiece engages the housing.

18. The communication headset according to claim 16, wherein the microphone boom is disengagably connected to the earpiece.

19. The communication headset according to claim 18, further comprising a retractable cord operably associated with the microphone boom, wherein the retractable cord is protracted from the earpiece when the microphone boom is disengaged.

20. A communication headset, comprising:
an earpiece adapted to interface with an ear of a user;
a microphone boom having a microphone proximate to a first distal end of the boom, and a second distal end of the boom pivotally and disengageably connected to said earpiece; and
a retractable cord operably associated with the microphone boom, wherein the retractable cord is protracted when the microphone boom is disengaged.

21. The communication headset according to claim 20, wherein the a retracted portion of the retractable cord is disposed within the earpiece, and the retractable cord protracts from a point proximate to the second distal end of the earpiece when engaged.

22. The communication headset according to claim 20, wherein the retractable cord is contained by a housing external to the earpiece

23. The communication headset according to claim 20, further comprising:
a transceiver configured to receive a signal from an external device and transmit a signal received from the microphone to the external device.

24. A communication system for connecting a communication device having a duplex connector with a first auxiliary device and a second auxiliary device, comprising
an adapter for connecting the duplex connector of the communication device to the first auxiliary device and the second auxiliary device, configured to selectively transmit a first signal output by the communication device via the duplex connector to either the first auxiliary device or the second auxiliary device and to transmit a second signal received from the first auxiliary device to the communication device via the duplex connector,
wherein the first auxiliary device is a headset configured to receive the first signal via the adapter when selected and transmit the second signal to the adapter.

25. The communication device according to claim 24, wherein the headset is integrally connected to the adapter.

26. The communication device according to claim 25, wherein a cord connecting to the headset is retractable from the adapter.

27. A mounting device for mounting a communication device adapter configured to connect the communication device with a first auxiliary device and a second auxiliary device, the mounting device comprising:
a flexible arm having first and second distal ends, the commincation device adapter connected to the first distal end;
an adjustable brace configured to clinch to a mounting surface, wherein the second distal end of the flexible arm is detachably connected to the adjustable brace.

28. The mounting device according to claim 27, wherein the adjustable brace includes gripping surfaces having disposed thereon non-abrasive and moderately frictional material for contacting the mounting surface.

29. The mounting device according to claim 27, wherein the adjustable brace is a vise.

30. The mounting device according to claim 27, wherein the adjustable brace is a clip.

31. The mounting device according to claim 27, further comprising a ratchet disposed between the first distal end of the flexible arm and the communication device adapter, for incrementally rotating the communication device adapter.

32. A communication device for connecting a communication device having a duplex connector with a first auxiliary device, comprising
an adapter including a speaker pivotally connected to a back side of the adapter, for connecting to the communication device via the duplex connector to the speaker and first auxiliary device, and configured to selectively transmit a first signal output by the communication device via the duplex connector to either the first auxiliary device or the speaker and to transmit a second signal received from the first auxiliary device to the communication device via the duplex connector.
